(19) United States
(12) Patent Application Publication
(10) Pub. No.: US 2013/0107866 A1
(43) Pub. Date: May 2, 2013

(54) FEMTOCELL AND RESOURCE CONTROL METHOD THEREOF

(71) Applicants: Chun-Teh Leu, Taipei City (TW); Kun-Lin Wu, Zhongli City (TW); Wen-Hsin Wei, Taipei City (TW)

(72) Inventors: Chun-Teh Leu, Taipei City (TW); Kun-Lin Wu, Zhongli City (TW); Wen-Hsin Wei, Taipei City (TW)

(21) Appl. No.: 13/312,226

(22) Filed: Dec. 6, 2011

(30) Foreign Application Priority Data
Nov. 1, 2011 (TW) 100139685

(51) Int. Cl. H04B 7/216; H04W 72/04

(52) U.S. Cl. 370/335

(57) ABSTRACT

A femtocell and a resource control method thereof are provided. The femtocell comprises a processor and a transceiver. The processor is configured to determine that a service resource of the femtocell reaches a saturation value, reduce a transmitting power of a primary common pilot channel power signal, and set a parameter of a system information block message as a barred state. The transceiver is electrically connected to the processor and configured to transmit the primary common pilot channel power signal and the system information block message.

This application claims the benefit of priority based on Taiwan Patent Application No. 100139685 filed on Nov. 1, 2011, which is hereby incorporated by reference in its entirety.

### CROSS-REFERENCES TO RELATED APPLICATIONS

Not applicable.

### BACKGROUND OF THE INVENTION

1. Field of the Invention

The present invention relates to a femtocell and resource control method thereof. More particularly, when the femtocell of the present invention determines that a service resource thereof reaches a saturation value, the femtocell can reduce a transmitting power of a primary common pilot channel power signal and set a parameter of a system information block message as a barred state so that a user device that is not connected to the femtocell can automatically select or reselect a macrocell as an expected connection cell.

2. Descriptions of the Related Art

With the advancement of science and technologies, communication requirements have increased and correspondingly, the requirements on the quality of service (QoS) of communications have also become higher. As femtocell technologies become more sophisticated and the requirements on the communication quality have increased in wide band code division multiple access (WCDMA) network systems, the practice of deploying a number of femtocells within a signal coverage area of a macrocell to improve the communication quality has become increasingly popular. However, as both the number and the density of user devices increase, the method of effectively utilizing communication resources of the macrocell and the femtocells have become increasingly important.

The number of user devices that can be served by a femtocell is much smaller than that can be served by a macrocell. When the number of user devices served by a femtocell reaches the maximum value (i.e., when the service resources that can be provided reach an upper limit), the femtocell will instruct the user device which submits a connection request to wait and then try to submit the connection request again after a while, or instruct the user device to be redirected to the macrocell. Consequently, the required time for the user device to obtain the connection (from the femtocell or from the macrocess) is delayed, and the burden on the femtocell is increased.

Accordingly, an urgent need exists in the art to provide a solution capable of avoiding the delay in time for a user device to obtain the connection and to ease the burden on the femtocell so that the communication resources of the macrocell and the femtocell can be efficiently utilized.

### SUMMARY OF THE INVENTION

An objective of the present invention is to provide a femtocell and a resource control method thereof. When the femtocell of the present invention determines that the number of user devices it can serve reaches the maximum value, the femtocell can adjust a transmitting power of a primary common pilot channel power signal and set a parameter of a system information block message as a barred state so that the user device will not submit a connection request to the femtocell. Then, the user device will directly submit the connection request to the macrocell instead. In this way, the femtocell of the present invention can not only avoid the delay in time for the user device to obtain a connection and ease the burden of the femtocell, but also allow for more efficient use of communication resources of the macrocell and the femtocell.

To achieve the aforesaid objective, the present invention discloses a femtocell, which is used in a wide band code division multiple access (WCDMA) network system. The WCDMA network system comprises a macrocell and the femtocell. The femtocell comprises a processor and a transceiver. The processor is configured to determine that service resource of the femtocell reaches a saturation value, reduce a transmitting power of a primary common pilot channel power signal, and set a parameter of a system information block message as a barred state. The transceiver is electrically connected to the processor and is configured to transmit the primary common pilot channel power signal and the system information block message.

To achieve the aforesaid objective, the present invention further discloses a resource control method for the aforesaid femtocell. The resource control method comprises the following steps: (a) determining that a service resource of the femtocell reaches a saturation value; (b) reducing a transmitting power of a primary common pilot channel power signal; (c) setting a parameter of a system information block message as a barred state; and (d) transmitting the primary common pilot channel power signal and the system information block message.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 is a schematic view of a WCDMA network system 1 according to the first and second embodiments of the present invention;

FIG. 2 is a schematic view of a femtocell 13 according to the first and second embodiments of the present invention;

FIG. 3 is a flowchart diagram of a resource control method according to the third embodiment of the present invention; and

FIG. 4 is a flowchart diagram of a resource control method according to the fourth embodiment of the present invention.

### DESCRIPTION OF THE PREFERRED EMBODIMENT

The present invention provides a femtocell and a resource control method thereof. In the following descriptions, the present invention will be explained with reference to embodiments thereof. However, these embodiments are not intended to limit the present invention to any specific environment, applications or particular implementations described in these embodiments. Therefore, the description of these embodiments is only for purpose of illustration rather than to limit the present invention. It should be appreciated that, in the following embodiments and the attached drawings, elements unrelated to the present invention are omitted from depiction.

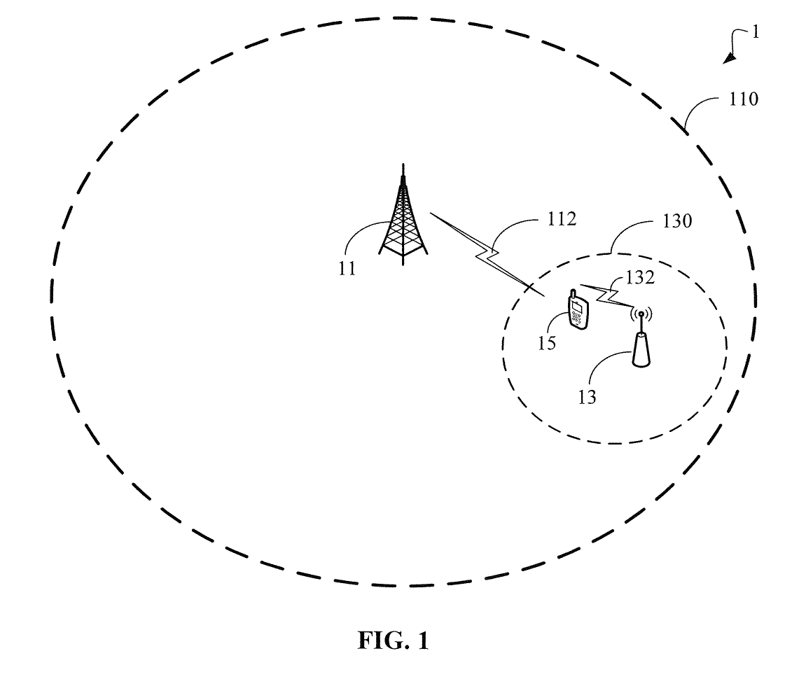

FIG. 1 is a schematic view of the first embodiment of the present invention, which depicts a wide band code division multiple access (WCDMA) network system 1. The WCDMA network system 1 comprises a macrocell 11 and a femtocell 13. The macrocell 11 has a signal coverage area 110. The femtocell 13 is disposed in the signal coverage area 110 of the macrocell 11 and has a signal coverage area 130 smaller than that of the macrocell 11. It shall be appreciated that, in practice, the WCDMA network system 1 comprises a plurality of femtocells 13 and the femtocells 13 are usually distributed uniformly in the signal coverage area 110 of the macrocell 11 to provide a desirable communication quality within short distances. For purpose of simplicity, the operations between the macrocell 11 and a user device 15 will be described hereinbelow with reference to only one femtocell 13.

The macrocell 11 and the femtocell 13 transmit signals in different frequency bands, and transmit a primary common pilot channel power signal 112 and a primary common pilot channel power signal 132 respectively in respective frequency bands. In this embodiment, the user device 15 is located within the signal coverage area 110 of the macrocell 11 and the signal coverage area 130 of the femtocell 13, and has not connected to the macrocell 11 or the femtocell 13 yet. The user device 15 receives the primary common pilot channel power signal 112 from the macrocell 11 and the primary common pilot channel power signal 132 from the femtocell 13, and then selects either the macrocell 11 or the femtocell 13 as the expected connection cell according to the receiving power of the primary common pilot channel power signal 112 and the receiving power of the primary common pilot channel power signal 132.

For example, if the receiving power of the primary common pilot channel power signal 112 received by the user device 15 is −60 dBm and the receiving power of the primary common pilot channel power signal 132 received by the user device 15 is −40 dBm, then the user device 15 selects the femtocell 13 as an expected connection cell. It shall be appreciated that, the receiving power of the primary common pilot channel power signal 112 and the receiving power of the primary common pilot channel power signal 132 received by the user device 15 vary with the location (i.e., distances from the macrocell 11 and the femtocell 13) of the user device 15, so generally the user device 15 automatically selects either the marcrocell 11 or the femtocell 13 which constitutes a larger receiving power as the expected connection cell.

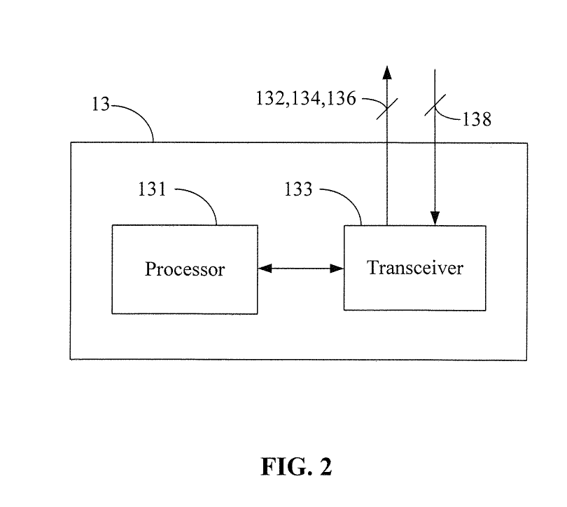

FIG. 2 is a schematic view of the femtocell 13 of the present invention. The femtocell 13 comprises a processor 131 and a transceiver 133. The processor 131 is configured to determine whether a service resource (e.g., the number of user devices that can be served) of the femtocell 13 reaches a saturation value (e.g., the maximum number of user devices that can be served is 20). The transceiver 133 is electrically connected to the processor 131 and is configured to transmit the primary common pilot channel power signal 132 and a system information block (SIB) message 134. If it is determined that the service resource of the femtocell 13 has reached the saturation value, then the processor 131 reduces the transmitting power of the primary common pilot channel power signal 132 and sets the parameter of the system information block message as a barred state.

For example, under normal conditions (i.e., when the service resource has not reached the saturation value), the transmitting power of the primary common pilot channel power signal 132 is maintained at a preset value (e.g., 0 dBm) and the parameter of the system information block message 134 is set as a non-barred state. However, when the service resource reaches the saturation value, the transmitting power of the primary common pilot channel power signal 132 is reduced to a low power value (e.g., −40 dBm) and the parameter of the system information block message 134 is set as the barred state. Then, the receiving power of the primary common pilot channel power signal 132 received by the user device 15 from the femtocell 13 will be significantly reduced (e.g., −80 dBm), and the user device 15 can know from the barred state represented by the parameter of the system information block message 134 that the service resource of the femtocell 13 has reached the saturation value. In this case, the user device 15 will directly select or reselect the macrocell 11 as an expected connection cell and submit a connection request to the macrocell 11 when a connection is desired. In this way, the delay in time for the user device 15 to obtain a connection is avoided and the burden of the femtocell 13 is eased (i.e., it is avoided that the femtocell 13 receives a connection request from the user device 15 and responds to the connection request).

Furthermore, if the user device 15 is just powered on and has not determined the expected connection cell yet, the user device 15 automatically selects the macrocell 11 as the expected connection cell directly when the receiving power of the primary common pilot channel power signal 132 is smaller than the receiving power of the primary common pilot channel power signal 112. Furthermore, if the user device 15 has selected the femtocell 13 as the expected connection cell, then the user device 15 automatically reselects the macrocell 11 as the expected connection cell when the receiving power of the primary common pilot channel power signal 132 is smaller than the receiving power of the primary common pilot channel power signal 112.

On the other hand, if the user device 15 is originally located at the edge of the signal coverage area 130 of the femtocell 13 and has selected the macrocell 11 as the expected connection cell, then the user device 15 continuously selects the macrocell 11 as the expected connection cell. In other words, for the user device 15, in which the receiving power of the primary common pilot channel power signal 132 is originally smaller than the receiving power of the primary common pilot channel power signal 112, the user device 15 will not reselect the femtocell 13 as the expected connection line unless it comes very close to the femtocell 13 to such an extent that the receiving power of the adjusted primary common pilot channel power signal 132 becomes larger than the receiving power of the primary common pilot channel power signal 112.

On the other hand, for a user device 15 which has moved to very close to the femtocell 13, the receiving power of the adjusted primary common pilot channel power signal 132 becomes larger than the receiving power of the primary common pilot channel power signal 112. However, because the user device 15 also receives the system information block message 134 and reads the barred state represented by the parameter of the system information block message 134, the user device 15 will automatically continuously select the macrocell 11 as the expected connection cell according to the barred state. Furthermore, for a user device 15 which originally has already been very close to the femtocell 13, the user device 15 will receive the system information block message 134 when the receiving power of the adjusted primary common pilot channel power signal 132 becomes larger than the receiving power of the primary common pilot channel power signal 112, read the barred state represented by the parameter of the system information block message 134 and automatically reselect the macrocell 11 as the expected connection cell according to the barred state.

In addition, when the processor 131 determines that the service resource of the femtocell 13 is partially released (i.e., fall to below the saturation value), the processor 131 recovers the transmitting power of the primary common pilot channel power signal 132 to a preset value (e.g., from −40 dBm to 0 dBm) and re-sets the parameter of the system information block message 134 as the non-barred state. In other words, when there is a user device that goes offline so that the femtocell 13 is able to accept a connection request from another user device, the transmitting power of the primary common pilot channel power signal 132 is recovered to the preset value and the parameter of the system information block message 134 is reset as the non-barred state so that the nearby user device can select the femtocell 13 as the expected connection cell.

It shall be appreciated that the transmitting power values and the receiving power values described above are only illustrated as examples, but are not intended to limit the scope of the present invention. Additionally, the service resource and the corresponding saturation value may be any other items acting as the basis for determining the burden level of the femtocell 13, but is not limited to the number of user devices that can be served.

The second embodiment of the present invention will be described also with reference to FIGS. 1 and 2. The second embodiment differs from the first embodiment in that the processor 131 is further configured to set a transport channel block error rate threshold and generate a measurement control message 136, and the transceiver 133 is further configured to transmit the measurement control message 136 and receive a measurement report message 138 carrying a transport channel block error rate.

Specifically, in conventional practice, for a user device 15 that is already connected to the femtocell 13, the femtocell 13 determines whether the user device 15 needs to perform a handover procedure or not according to the receiving power of the primary common pilot channel power signal 132 reported by the user device 15. However, in the present invention, because the femtocell 13 reduces the transmitting power of the primary common pilot channel power signal 132 when the service resource reaches a saturation value, the primary common pilot channel power signal 132 becomes unsuitable for use as a basis to determine whether the user device 15 needs to perform a handover procedure or not.

To determine whether the user device 15 that has been connected to the femtocell 13 needs to perform a handover procedure or not in the present invention, the femtocell 13 transmits the measurement control message 136 to the user device 15 so that the user device 15 reports the measurement report message 138 according to the measurement control message 136. Because the measurement report message 138 carries the transport channel block error rate of the user device 15, the processor 131 of the femtocell 13 may further determine whether the user device 15 needs to perform the handover procedure by comparing the transport channel block error rate with the transport channel block error rate threshold after receiving the measurement report message 138.

In other words, if the transport channel block error rate of the user device 15 is higher than the transport channel block error rate threshold, then the femtocell 13 can learn that the receiving signal quality of the user device 15 has degraded to such an extent that a handover procedure needs to be performed. Then, the femtocell 13 notifies the user device 15 to perform the handover procedure. Because this embodiment only focuses on how to determine whether the user device 15 needs to perform a handover procedure or not and the handover procedure is well known in the prior art, the handover procedure will not be detailed herein.

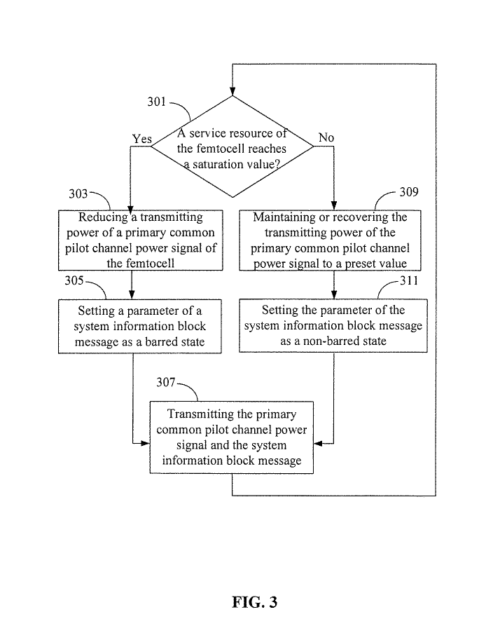

The third embodiment of the present invention is shown in FIG. 3, which is a flowchart diagram of a resource control method for a femtocell according to the present invention. The resource control method of the present invention is suitable for the femtocell 13 of the first embodiment. First, step 301 is executed to determine whether a service resource of the femtocell reaches a saturation value or not. If the answer is “yes”, then step 303 is executed to reduce a transmitting power of a primary common pilot channel power signal of the femtocell and step 305 is executed to set a parameter of a system information block message as a barred state.

Then, step 307 is executed to transmit the primary common pilot channel power signal and the system information block message. Thus, for a user device which is located in the signal coverage area of the femtocell and has selected the femtocell as an expected connection cell, if a receiving power of a primary common pilot channel power signal received from the femtocell is smaller than a receiving power of a primary common pilot channel power signal received from a macrocell, then the user device automatically reselects the macrocell as the expected connection cell; however, if the receiving power of the primary common pilot channel power signal received from the femtocell is larger than the receiving power of the primary common pilot channel power signal received from the macrocell, then the user device further receives the system information block message and automatically reselects the macrocell as the expected connection cell according to the barred state of the parameter.

Additionally, for a user device which is located within the signal coverage area and has selected the macrocell as an expected connection cell, if the receiving power of the primary common pilot channel power signal received from the femtocell is smaller than the receiving power of a primary common pilot channel power signal received from the macrocell, then the user device continuously selects the macrocell as the expected connection cell; however, if the receiving power of the primary common pilot channel power signal received from the femtocell is larger than the receiving power of the primary common pilot channel power signal received from the macrocell, then the user device further receives the system information block message and continuously selects the macrocell as the expected connection cell according to the barred state of the parameter.

On the other hand, if it is determined in the step 301 that the service resource of the femtocell has not reached the saturation value, then step 309 is executed to maintain or recover the transmitting power of the primary common pilot channel power signal of the femtocell to a preset value (e.g., 0 dBm). Then, step 311 is executed to set the parameter of the system information block message as a non-barred state. Next, step 307 is executed to transmit the primary common pilot channel power signal and the system information block message. It shall be noted that the femtocell returns back to the step 301 after the step 307 is executed. In other words, the femtocell periodically determines whether the service resource of the femtocell has reached the saturation value to adjust the transmitting power of the primary common pilot channel power signal thereof and set the parameter of the system information block message.

In addition to the aforesaid steps, the third embodiment can also execute all the operations and functions set forth in the first embodiment. How the resource control method of a femtocell according to the third embodiment executes these operations and functions will be readily appreciated by those of ordinary skill in the art based on the explanation of the first embodiment, and thus will not be further described herein.

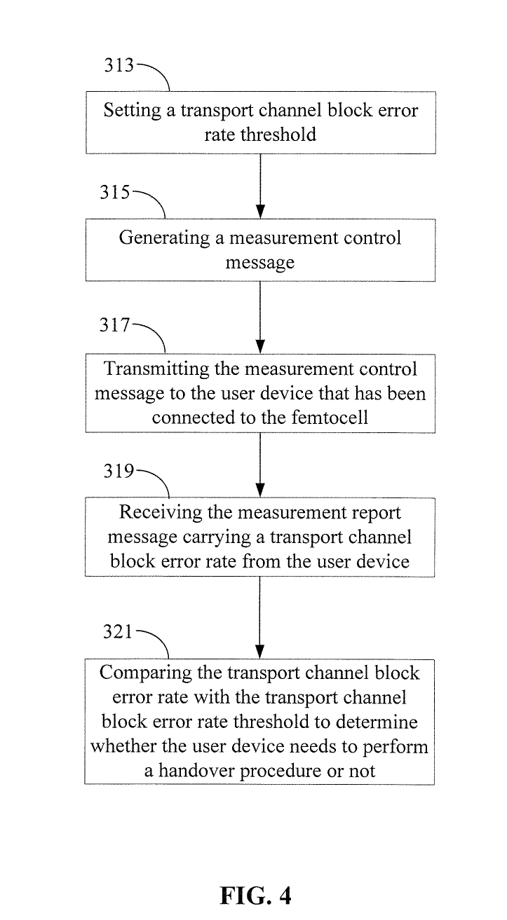

The fourth embodiment of the present invention is shown in FIG. 4, which is a flowchart diagram of a resource control method for a femtocell according to the present invention. The resource control method of this embodiment is suitable for the femtocell 13 of the second embodiment. For a user device that is located within the signal coverage area of the femtocell and has connected to femtocell, the following steps are further executed by the femtocell.

Firstly, step 313 is executed to set a transport channel block error rate threshold. Then, step 315 is executed to generate a measurement control message, and step 317 is executed to transmit the measurement control message to the user device that has been connected to the femtocell. After receiving the measurement control message, the user device transmits a measurement report message back according to the measurement control message. The measurement report message carries a transport channel block error rate. Next, step 319 is executed to receive the measurement report message carrying the transport channel block error rate from the user device, and step 321 is executed to compare the transport channel block error rate with the transport channel block error rate threshold to determine whether the user device needs to perform a handover procedure or not. If it is determined in the step 321 that the user device needs to perform the handover procedure, then the femtocell notifies the user device to prepare for the handover procedure.

In addition to the aforesaid steps, the fourth embodiment can also execute all the operations and functions set forth in the second embodiment. How the resource control method of a femtocell according to the fourth embodiment executes these operations and functions will be readily appreciated by those of ordinary skill in the art based on the explanation of the second embodiment, and thus will not be further described herein.

According to the above descriptions, when determining that the service resource of the femtocell reaches a saturation value, the femtocell and the resource control method thereof of the present invention adjusts a transmitting power of a primary common pilot channel power signal and sets a parameter of a system information block message as a barred state so that the user device will selects or reselects a macrocell as an expected connection cell. This can inhibit the user device from submitting a connection request to the femtocell. In this way, the present invention can avoid the delay in time for the user device to obtain the connection and ease the burden of the femtocell without modifying the hardware of the macrocell and the user device. Thereby, the communication resources of the macrocell and the femtocell can be utilized efficiently.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A femtocell used in a wide band code division multiple access (WCDMA) network system, the WCDMA network system comprising a macrocell and the femtocell, the femtocell comprising:
a processor, being configured to determine that a service resource of the femtocell reaches a saturation value, reduce a transmitting power of a primary common pilot channel power signal, and set a parameter of a system information block message as a barred state; and
a transceiver, being electrically connected to the processor and being configured to transmit the primary common pilot channel power signal and the system information block message.

2. The femtocell of claim 1, wherein the femtocell has a signal coverage area, and for a user device which is within the signal coverage area and has selected the femtocell as an expected connection cell, if a receiving power of the primary common pilot channel power signal of the femtocell is smaller than a receiving power of a primary common pilot channel power signal of the macrocell, then the user device automatically reselects the macrocell as the expected connection cell.

3. The femtocell of claim 2, wherein the user device further receives the system information block message, and automatically reselects the macrocell as the expected connection cell according to the barred state of the parameter if the receiving power of the primary common pilot channel power signal of the femtocell is larger than the receiving power of the primary common pilot channel power signal of the macrocell.

4. The femtocell of claim 1, wherein the femtocell has a signal coverage area, and for a user device which is within the signal coverage area and has selected the macrocell as an expected connection cell, if a receiving power of the primary common pilot channel power signal of the femtocell is smaller than a receiving power of a primary common pilot channel power signal of the macrocell, then the user device continuously selects the macrocell as the expected connection cell.

5. The femtocell of claim 4, wherein the user device further receives the system information block message, and continuously selects the macrocell as the expected connection cell according to the barred state of the parameter if the receiving power of the primary common pilot channel power signal of the femtocell is larger than the receiving power of the primary common pilot channel power signal of the macrocell.

6. The femtocell of claim 1, wherein the femtocell has a signal coverage area, and for a user device which is within the signal coverage area and has connected to the femtocell, the processor further sets a transport channel block error rate threshold and generates a measurement control message, the transceiver further transmits the measurement control message to the user device so that the user device transmits a measurement report message carrying a transport channel block error rate back according to the measurement control message, the transceiver further receives the measurement report message, and the processor further compares the transport channel block error rate with the transport channel block error rate threshold to determine whether the user device needs to perform a handover procedure or not.

7. The femtocell of claim 1, wherein the processor further determines that the service resource of the femtocell does not reach the saturation value so as to maintain or recover the transmitting power of the primary common pilot channel power signal to a preset value, and set the parameter of the system information block message as a non-barred state.

8. A resource control method of a femtocell used in a WCDMA network system, the WCDMA network system comprising a macrocell and the femtocell, the resource control method comprising:
(a) determining that a service resource of the femtocell reaches a saturation value;
(b) reducing a transmitting power of a primary common pilot channel power signal;
(c) setting a parameter of a system information block message as a barred state; and
(d) transmitting the primary common pilot channel power signal and the system information block message.

9. The resource control method of claim 8, wherein the femtocell has a signal coverage area, and for a user device which is within the signal coverage area and has selected the femtocell as an expected connection cell, if a receiving power of the primary common pilot channel power signal of the femtocell is smaller than a receiving power of a primary common pilot channel power signal of the macrocell, then the user device automatically reselects the macrocell as the expected connection cell.

10. The resource control method of claim 9, wherein the user device further receives the system information block message, and automatically reselects the macrocell as the expected connection cell according to the barred state of the parameter if the receiving power of the primary common pilot channel power signal of the femtocell is larger than the receiving power of the primary common pilot channel power signal of the macrocell.

11. The resource control method of claim 8, wherein the femtocell has a signal coverage area, and for a user device which is within the signal coverage area and has selected the macrocell as an expected connection cell, if a receiving power of the primary common pilot channel power signal of the femtocell is smaller than a receiving power of a primary common pilot channel power signal of the macrocell, then the user device continuously selects the macrocell as the expected connection cell.

12. The resource control method of claim 11, wherein the user device further receives the system information block message, and continuously selects the macrocell as the expected connection cell according to the barred state of the parameter if the receiving power of the primary common pilot channel power signal of the femtocell is larger than the receiving power of the primary common pilot channel power signal of the macrocell.

13. The resource control method of claim 8, wherein the femtocell has a signal coverage area, and for a user device which is within the signal coverage area and has connected to the femtocell, the resource control method further comprises:
(e) setting a transport channel block error rate threshold;
(f) generating a measurement control message;
(g) transmitting the measurement control message to the user device;
(h) receiving the measurement report message carrying a transport channel block error rate from the user device; and
(i) comparing the transport channel block error rate with the transport channel block error rate threshold to determine whether the user device needs to perform a handover procedure or not.

14. The resource control method of claim 8, further comprising:
(j) determining that the service resource of the femtocell does not reach the saturation value;
(k) maintaining or recovering the transmitting power of the primary common pilot channel power signal to a preset value; and
(l) setting the parameter of the system information block message as a non-barred state.
